(19) United States
(12) Patent Application Publication
(10) Pub. No.: US 2025/0348185 A1
(43) Pub. Date: Nov. 13, 2025

(54) Dynamic Configuration Within Interactive Media Applications

(71) Applicant: Tencent Technology (Shenzhen) Company Limited, Shenzhen (CN)

(72) Inventor: Jie Xiao, Shenzhen (CN)

(21) Appl. No.: 19/278,305

(22) Filed: Jul. 23, 2025

Related U.S. Application Data
(63) Continuation of application No. PCT/CN2024/093406, filed on May 15, 2024.

(30) Foreign Application Priority Data
Jul. 13, 2023 (CN) 2023108666024

(51) Int. Cl. G06F 3/0481; G06F 3/04845

(52) U.S. Cl. CPC G06F 3/0481; G06F 3/04845

(57) ABSTRACT

Dynamic configuration techniques for interactive media applications are described herein. The techniques may include displaying in a virtual scene corresponding to a first virtual character controlled by a target account, first indication information that the target account corresponds to a current configuration state. The current configuration state may include one or more of an interaction team to which the first virtual character controlled by the target account belongs, wherein the interaction team comprises at least one virtual character, or an equipment set used for interaction by the first virtual character, wherein the equipment set comprises at least two types of virtual equipment. The techniques may further include displaying at least one candidate configuration state in response to a switching operation performed on the current configuration state; switching, in response to a received selection operation performed on a target configuration state, the target account to the target configuration state; and displaying second indication information of the target configuration state in the second interaction image.

### CROSS-REFERENCE TO RELATED APPLICATIONS

This application is a Continuation Application of PCT Application PCT/CN2024/093406, filed May 15, 2025, which claims priority to Chinese Patent Application No. 2023108666024, filed Jul. 13, 2023, each entitled “Method and Apparatus for Interaction in Virtual Scene, Device, Storage Medium, and Program Product” and each of which is incorporated herein by reference in its entirety.

### FIELD

This application relates to a human-computer interaction technology, and in particular, to a method and apparatus for interaction in a virtual scene, a device, a storage medium, and a program product.

### BACKGROUND

A display technology based on graphics processing hardware expands channels for environment sensing and information obtaining. In particular, a virtual scene display technology can achieve diversified interactions between virtual objects controlled by a user or by artificial intelligence according to an actual application demand, and is applicable to various typical application scenes. For example, the display technology can emulate a real combat process between the virtual objects in a virtual scene such as a game.

In a process in which a target account (a player) controls a virtual character to interact in a virtual scene, if a current configuration state needs to be switched, in the related art, it usually needs to jump to a configuration interface for state configuration and selection. For example, when an interaction team currently controlled by the target account needs to be switched to another interaction team, the player needs to jump to a formation interface for team configuration and selection, or when an equipment set currently used by the virtual character needs to be switched to another equipment set, the player needs to jump to an equipment configuration interface for equipment configuration and selection. This interrupts the immersion and experience of the player.

### SUMMARY

Aspects described herein provide a method and apparatus for interaction in a virtual scene, an electronic device, a computer-readable storage medium, and a computer program product. Immersion of an interaction process can be enhanced.

Technical solutions of aspects described herein may be implemented as follows:

An aspect described herein provides a method for interaction in a virtual scene, including:
displaying a first interaction image of interaction performed, in the virtual scene, by a first virtual character controlled by a target account, and displaying, in the first interaction image, first indication information that the target account corresponds to a current configuration state,
the current configuration state including at least one of the following: an interaction team to which the first virtual character controlled by the target account belongs, and an equipment set used for interaction by the first virtual character, the interaction team including at least one virtual character, and the equipment set including at least two types of virtual equipment;
displaying at least one candidate configuration state in the first interaction image in response to a switching operation performed on the current configuration state; and
switching, in response to a selection operation performed on a target configuration state, the first interaction image to a second interaction image in which the target account corresponds to the target configuration state, and displaying second indication information of the target configuration state in the second interaction image.

An aspect described herein provides an apparatus for interaction in a virtual scene, including:
a first display module, configured to: display a first interaction image of interaction performed, in the virtual scene, by a first virtual character controlled by a target account, and display, in the first interaction image, first indication information that the target account corresponds to a current configuration state,
the current configuration state including at least one of the following: an interaction team to which the first virtual character controlled by the target account belongs, and an equipment set used for interaction by the first virtual character, the interaction team including at least one virtual character, and the equipment set including at least two types of virtual equipment;
a second display module, configured to display at least one candidate configuration state in the first interaction image in response to a switching operation performed on the current configuration state; and
a third display module, configured to: switch, in response to a selection operation performed on a target configuration state, the first interaction image to a second interaction image in which the target account corresponds to the target configuration state, and display second indication information of the target configuration state in the second interaction image.

An aspect described herein provides an electronic device, including:
a memory, configured to store a computer-executable instruction or a computer program; and
a processor, configured to implement the method for interaction in a virtual scene according to an aspect described herein when executing the computer-executable instruction or the computer program stored in the memory.

An aspect described herein further provides a computer-readable storage medium, having a computer-executable instruction or a computer program stored thereon, the computer-executable instruction or the computer program, when executed by a processor, implementing the method for interaction in a virtual scene according to an aspect described herein.

An aspect described herein provides a computer program product, including a computer program or a computer-executable instruction, the computer program or the computer-executable instruction, when executed by a processor, implementing the method for interaction in a virtual scene according to an aspect described herein.

The aspects described herein have the following beneficial effects:

By applying the aspects described herein, in a process in which a target account controls a first virtual object to interact in a virtual scene, first indication information that the target account corresponds to a current configuration state is displayed in a first interaction image of the first virtual object. If a switching operation performed on the current configuration state is triggered, candidate configuration states for selection are displayed in the first interaction image. After a target configuration state is selected from the candidate configuration states, the first interaction image currently displayed by a terminal is switched to a second interaction image in which the target account corresponds to the target configuration state, thereby implementing configuration state switching. In the switching process, displaying of the candidate configuration states and selection of the target configuration state are both directly implemented in the first interaction image. To be specific, the first interaction image is always displayed on a view interface of the terminal in the switching process, thereby avoiding interruption of the first interaction image, and enhancing immersion and experience in an interaction process.

### BRIEF DESCRIPTION OF THE DRAWINGS

FIG. 1 is a schematic diagram of an architecture of a system 100 for interaction in a virtual scene according to an aspect described herein.

FIG. 2 is a schematic structural diagram of an electronic device 500 according to an aspect described herein.

FIG. 3 is a flowchart of a method for interaction in a virtual scene according to an aspect described herein.

FIG. 4 is a schematic diagram of displaying of an interaction image according to an aspect described herein.

FIG. 5 is a schematic diagram of displaying of an interaction image according to an aspect described herein.

FIG. 6 is a schematic diagram of displaying of candidate interaction teams according to an aspect described herein.

FIG. 7 is a schematic diagram of configuration of candidate interaction teams according to an aspect described herein.

FIG. 8 is a schematic diagram of configuration of a candidate interaction team according to an aspect described herein.

FIG. 9 is a schematic diagram of configuration of a candidate interaction team according to an aspect described herein.

FIG. 10 is a schematic diagram of displaying of prompt information according to an aspect described herein.

FIG. 11 is a schematic diagram of displaying of an interaction image according to an aspect described herein.

FIG. 12 is a schematic diagram of configuration of a candidate equipment set according to an aspect described herein.

FIG. 13 is a flowchart of a method for interaction in a virtual scene according to an aspect described herein.

### DESCRIPTION OF ASPECTS

To make the objectives, technical solutions, and advantages described herein clearer, the following describes this application in further detail with reference to the accompanying drawings. The described aspects are not to be considered as a limitation to this application. All other aspects obtained by a person of ordinary skill in the art without creative efforts shall fall within the protection scope described herein.

In the aspects described herein, relevant data such as user information (for example, a trigger operation of a user, a team attribute, or a character feature) is involved. When the aspects described herein are applied to specific products or technologies, user permission or consent is required, and collection, use, and processing of the relevant data need to comply with relevant laws, regulations, and standards of relevant countries and regions.

In the following descriptions, related “some aspects” describe a subset of all possible aspects. However, the “some aspects” may be the same subset or different subsets of all the possible aspects, and may be combined with each other without conflict.

In the following descriptions, the related term “first, second, . . . ” is merely intended to distinguish between similar objects rather than represent a particular sequence of the objects. A particular sequence or a chronological order indicated by “first, second, . . . ” may be changed, so that the aspects described herein described herein can be implemented in a sequence other than the sequence illustrated or described herein.

Unless otherwise defined, meanings of all technical and scientific terms used in this specification are the same as those usually understood by a person skilled in the art to which this application belongs. Terms used herein are merely intended to describe the aspects described herein, but are not intended to limit this application.

Before the aspects described herein are further described in detail, a description is made on nouns and terms in the aspects described herein, and the nouns and terms in the aspects described herein are applicable to the following explanations.
1) Client: It is an application program run in a terminal to provide various services, such as a video playing client and a game client.
2) Being in response to: It is configured for representing a condition or state on which a performed operation depends. When the dependent condition or state is satisfied, one or more operations performed may be in real time or may have a set delay. Without being specifically stated, there is no limitation to the order in which the operations are performed.
3) Virtual scene: It is a virtual scene displayed (or provided) when an application program is run on a terminal. The virtual scene can be a simulation environment of the real world, a semi-simulation and semi-fictitious virtual environment, or a purely fictitious virtual environment. The virtual scene may be any one of a two-dimensional virtual scene, a 2.5-dimensional virtual scene, or a three-dimensional virtual scene, and the dimension of the virtual scene is not limited in the aspects described herein. For example, the virtual scene may include the sky, land, or ocean. The land may include an environment element such as a desert or a city. A user may control a virtual object to move in the virtual scene.
4) Virtual character: It represents images of various persons and things for interaction in a virtual scene, or movable objects in the virtual scene. The movable object may be a virtual character, a virtual animal, an animation character, and the like, such as a person and an animal displayed in the virtual scene. The virtual character may be a virtual image for representing a user in the virtual scene. The virtual scene may include a plurality of virtual characters, and each virtual character has a shape and a volume in the virtual scene, and occupies some space in the virtual scene. The virtual character may alternatively be a game character controlled by a user (or referred to as a player).
5) Interaction team: It is a team in which a virtual character controlled by a target account (or a player) is located. An interaction team may include one or more virtual characters. When the interaction team includes a plurality of virtual characters, the target account may control the plurality of virtual characters in the interaction team to interact in a virtual scene. In this case, each virtual character has relatively limited skills (for example, each virtual character has no more than two virtual skills). In an interaction process, different virtual characters need to cooperate with each other to complete an interaction purpose (for example, a game combat). Therefore, the player needs to switch different virtual characters in the interaction team to complete the interaction purpose.
6) Equipment set: It is an equipment set equipped for a virtual object controlled by a target account. Usually, each equipment set includes a plurality of types of virtual equipment. The virtual equipment may be a virtual prop or a virtual skill, and is an interaction tool used by the virtual object in a virtual scene, for example, a virtual firearm, a magazine or a bullet of a virtual firearm, a virtual prop (such as an armor, a container, or a bullet-hanging system) equipped on the virtual object, a virtual prop (such as a helmet, a mask, or a headset) equipped on the head of the virtual object, or a supplementary prop (such as a medicine or food) stored in a pocket of the virtual object or a container. In actual application, the various types of virtual equipment may be combined, and an equipment set obtained through the combination is equipped on a virtual object, to better assist the virtual object in interacting with another virtual object in a virtual scene.

Aspects described herein provide a method and apparatus for interaction in a virtual scene, an electronic device, a computer-readable storage medium, and a computer program product. Immersion of an interaction process can be enhanced. An illustrative application of an electronic device according to an aspect described herein will be described below. The electronic device according to this aspect described herein may be implemented as various types of user terminals such as a notebook computer, a tablet computer, a desktop computer, a set-top box, a mobile device (for example, a mobile phone, a portable music player, a personal digital assistant, a dedicated messaging device, or a portable game device), a smartphone, a smart speaker box, a smart watch, a smart TV, and an in-vehicle terminal, or may be implemented as a server. An illustrative application in which a device is implemented as a terminal device is described below.

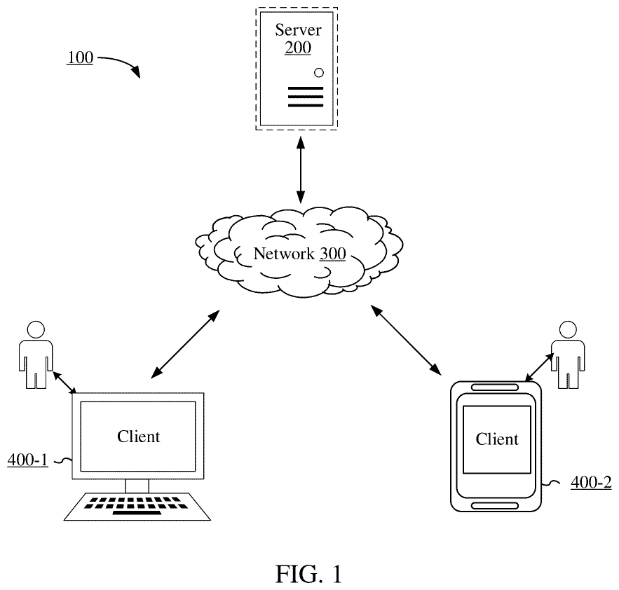

FIG. 1 is a schematic diagram of an architecture of a system 100 for interaction in a virtual scene according to an aspect described herein. To support an illustrative application, a terminal (for example, a terminal 400-1 and a terminal 400-2 are shown) is connected to a server 200 through a network 300. The network 300 may be a wide area network, or a local area network, or a combination of the wide area network and the local area network, and uses a wireless or wired link for data transmission.

In some aspects, the terminal may be, but is not limited to, a smartphone, a tablet computer, a laptop, a desktop computer, a smart speaker, a smart watch, an in-vehicle terminal, or the like. The terminal is configured with a client having a livestreaming function, such as a video playback client, an instant messaging client, a game client, or a livestreaming client. The server 200 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The terminal and the server may be connected directly or indirectly to the server in a wired or wireless communication protocol. This is not limited in the aspects described herein.

In actual application, the terminal displays a first interaction image of interaction performed, in a virtual scene, by a first virtual character controlled by a target account, and displays, in the first interaction image, first indication information that the target account corresponds to a current configuration state, the current configuration state including at least one of the following: an interaction team to which the first virtual character controlled by the target account belongs, and an equipment set used for interaction by the first virtual character, the interaction team including at least one virtual character, and the equipment set including at least two types of virtual equipment; and transmits a state switching request to the server 200 in response to a switching operation performed on the current configuration state. The server 200 obtains, based on the state switching request, at least one candidate configuration state corresponding to the target account, and returns the at least one candidate configuration state to the terminal. The terminal displays the at least one candidate configuration state in the first interaction image, switches, in response to a selection operation performed on a target configuration state, the first interaction image to a second interaction image in which the target account corresponds to the target configuration state, and displays second indication information of the target configuration state in the second interaction image.

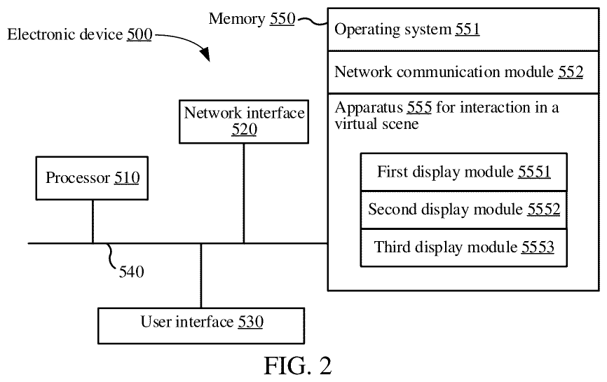

FIG. 2 is a schematic structural diagram of an electronic device 500 according to an aspect described herein. An example in which the electronic device 500 is the terminal in FIG. 1 is used. The electronic device 500 shown in FIG. 2 includes: at least one processor 510, a memory 550, at least one network interface 520, and a user interface 530. The components in the electronic device 500 are coupled together by using a bus system 540. The bus system 540 is configured to implement connection and communication between the components. In addition to a data bus, the bus system 540 further includes a power bus, a control bus, and a state signal bus. However, for clarity of description, all types of buses in FIG. 2 are marked as the bus system 540.

The processor 510 may be an integrated circuit chip having a signal processing capability, for example, a general-purpose processor, a digital signal processor (DSP), another programmable logic device, discrete gate or transistor logic device, or discrete hardware component, or the like. The general-purpose processor may be a microprocessor or any conventional processor, or the like.

The memory 550 includes a volatile memory or a non-volatile memory, or may include both a volatile memory and a non-volatile memory. The non-volatile memory may be a read-only memory (ROM). The volatile memory may be a random access memory (RAM). The memory 550 described in this aspect described herein is to include any other suitable types of memories. The memory 550 alternatively includes one or more storage devices away from the processor 510 in physical positions.

In some aspects, the memory 550 may store data to support various operations. Examples of the data include a program, a module, and a data structure or other subsets or supersets, which are exemplified below.

An operating system 551 includes system programs for processing various basic system services and performing hardware-related tasks, such as a framework layer, a kernel library layer, and a drive layer, and is configured to implement various basic services and process hardware-based tasks. A network communication module 552 is configured to reach other electronic devices via one or more (wired or wireless) network interfaces 520. The network interface 520 illustratively includes: Bluetooth, a wireless fidelity (WiFi), universal serial bus (USB), and the like.

In some aspects, an apparatus for interaction in a virtual scene according to the aspects described herein may be implemented in a software manner. The apparatus for interaction in the virtual scene according to the aspects described herein may be provided in various software aspects, including various forms such as an application program, software, a software module, a script, or a code. FIG. 2 shows an apparatus 555 for interaction in a virtual scene, which is stored in the memory 550. The apparatus 555 for interaction in the virtual scene may be software in a form of a program and a plug-in, and include a series of modules: a first display module 5551, a second display module 5552, and a third display module 5553. These modules are logical and may be arbitrarily combined or further split depending on functions implemented. Functions of the modules will be described below.

In some other aspects, the apparatus according to the aspects described herein may be implemented in a hardware manner. For example, the apparatus according to the aspects described herein may be a processor in the form of a hardware decoding processor, programmed to perform the method for interaction in the virtual scene according to the aspects described herein. For example, the processor in the form of the hardware decoding processor may use one or more application specific integrated circuits (ASIC), a DSP, a programmable logic device (PLD), a complex programmable logic device (CPLD), a field-programmable gate array (FPGA), or other electronic components.

In some aspects, the terminal or the server may implement the method for interaction in the virtual scene according to the aspects described herein by executing various computer-executable instructions or computer programs. For example, the computer-executable instructions may be a microprogram-level command, machine instructions, or software instructions. The computer program may be an original program or a software module in an operating system, may be a native application (APP), i.e., a program that needs to be installed in the operating system to run, such as an instant messaging APP or a livestreaming APP, or may be a mini program that can be embedded into any APP, i.e. a program that only needs to be downloaded into a browser environment to run. In a word, the above computer-executable instruction may be any form of instruction, and the above computer program can be any form of application program, module, or plug-in.

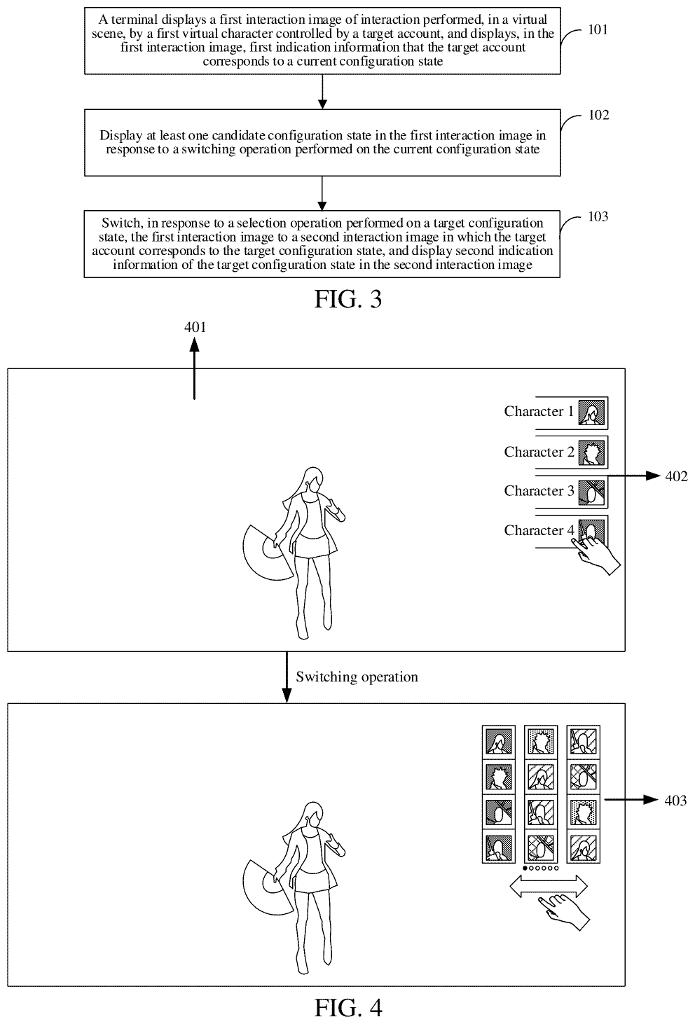

As mentioned above, the method for interaction in the virtual scene according to the aspects described herein may be implemented by various types of electronic devices. For example, the method may be performed independently by any one of the terminal and the server 200 in FIG. 1 or may be performed synergistically by the terminal and the server 200 in FIG. 1. Next, an example is used for explanation, in which the terminal in FIG. 1 independently performs the method for interaction in the virtual scene according to the aspects described herein. FIG. 3 is a flowchart of a method for interaction in a virtual scene according to an aspect described herein, which will be explained in conjunction with operations shown in FIG. 3.

Operation 101: A terminal displays a first interaction image of interaction performed, in the virtual scene, by a first virtual character controlled by a target account, and displays, in the first interaction image, first indication information that the target account corresponds to a current configuration state.

In actual application, a client that supports the virtual scene is installed on the terminal (for example, when the virtual scene is a game, a corresponding client may be a shooting game APP). When a user opens the client installed on the terminal and the terminal runs the client, the first interaction image of the interaction (for example, a first virtual object moves in the virtual scene or interacts with another virtual object in the virtual scene) performed, in the virtual scene, by the first virtual character controlled by the target account (i.e., an account corresponding to the current terminal) may be displayed on the client, and the first indication information that the target account corresponds to the current configuration state is displayed in the first interaction image. The first interaction image is a main user interface that always floats on a view interface in an interaction process. For example, when the virtual scene is a game, the first interaction image is a current Big World head-up display (HUD) in the game, a main user interface that always floats on a game image in a gaming process, or is a hot zone in which players perform interaction behaviors.

The current configuration state corresponding to the target account includes at least one of the following: an interaction team to which the first virtual character controlled by the target account belongs, and an equipment set used for interaction by the first virtual character, the interaction team including at least one virtual character, and the equipment set including at least two types of virtual equipment; and The first indication information is relevant information for indicating the current configuration state of the target account. For example, if the current configuration state includes the interaction team (e.g., an interaction team 1) to which the first virtual character controlled by the target account belongs, the first indication information is relevant information for indicating the interaction team 1, such as team attribute information (a team type or a function tendency, such as being good at attacking or defending) of the interaction team 1 or character information of virtual characters included in the interaction team 1 (such as a virtual character composition, a configuration sequence of the virtual characters in the team, or proficient skills of the virtual characters). If the current configuration state includes the equipment set used for interaction by the first virtual character (such as an equipment set 2 that is currently equipped on the first virtual character), the first indication information is related information for indicating the equipment set 2, such as an equipment set attribute of the equipment set 2 (such as a function tendency of the equipment set: shooting or replenishment) or equipment information (such as an equipment quantity and an equipment type) of virtual equipment (such as a virtual prop or a virtual skill) included in the equipment set 2.

In the foregoing manner, a player may clearly learn the current configuration state of the first virtual character through the first indication information, to facilitate subsequent switching of the configuration state with reference to an actual interaction of the first virtual character controlled by the target account in the virtual scene.

Operation 102: Display at least one candidate configuration state in the first interaction image in response to a switching operation performed on the current configuration state.

In some aspects, before the displaying at least one candidate configuration state in the first interaction image, the terminal may further receive the switching operation performed on the current configuration state in one of the following manners: receiving a first trigger operation performed on the first indication information, and using the first trigger operation as the switching operation performed on the current configuration state; receiving a second trigger operation performed on a switch control for switching the current configuration state, and using the second trigger operation as the switching operation performed on the current configuration state; displaying prompt information for prompting switching of a configuration state, and determining, when a confirming operation performed on the prompt information is received, that the confirming operation is the switching operation performed on the current configuration state; and displaying a display duration of the first indication information, and receiving the switching operation performed on the current configuration state when the display duration reaches a target duration.

In actual application, the switching operation may be actively triggered by the target account. For example, when the target account (a corresponding user) triggers the first indication information, the terminal receives the switching operation. Or, the terminal displays, at an associated position of the first indication information, the switch control for switching the current configuration state. When the target account triggers the switch control, the terminal receives the switching operation. Or, after displaying, in the first interaction image, the first indication information that the target account corresponds to the current configuration state, the terminal displays prompt information indicating whether to switch the current configuration state. The prompt information may be associated with a confirm control and a cancel control. If the target account intends to switch the current configuration state, the confirm control may be triggered. In this case, the terminal receives a confirming operation performed by the target account on the prompt information, and uses the confirming operation performed on the prompt information as the switching operation.

In addition, the switching operation may alternatively be automatically triggered by the terminal (not actively triggered by the target account) after a set switching condition is satisfied. For example, the current configuration state is switched when the switching condition is set to be from a display duration (i.e. an interaction duration, in the virtual scene, of a virtual character controlled by the target account in the current configuration state) of the first indication information to a target duration (which may be set, for example, to 5 minutes). When the target account in the current configuration state starts to control the interaction of the virtual character in the virtual scene, a switching countdown (namely, a total duration of the switching countdown is the above interaction duration, for example, 5 minutes) is displayed in the first interaction image. When the switching countdown returns to zero (namely, the interaction lasts for 5 minutes), the switching operation is automatically triggered.

Here, the trigger operation (for example, the first trigger operation and the second trigger operation) in this aspect described herein may be a tap operation, a touch and hold operation, a dragging operation, or an operation in another form. This aspect described herein does not limit a specific form of the trigger operation.

In some aspects, the terminal may display, in the following manner in the first interaction image, the first indication information that the target account corresponds to the current configuration state: displaying, in a target region having a preset transparency in the first interaction image, the first indication information that the target account corresponds to the current configuration state, where the target region is a partial region of the first interaction image. Correspondingly, the terminal may display the at least one candidate configuration state in the first interaction image in the following manner: displaying the at least one candidate configuration state in the target region of the first interaction image.

Here, in the process in which the target account controls the first virtual character to interact in the virtual scene, the first indication information is displayed in the target region in the first interaction image. When the terminal receives the switching operation performed on the current configuration state, the terminal displays the at least one candidate configuration state in the target region in the first interaction image in response to the switching operation. To be specific, in the interaction process, the first indication information and each candidate configuration state are directly displayed in the first interaction image.

FIG. 4 is a schematic diagram of displaying of an interaction image according to an aspect described herein. In a process of controlling, by a target account, a first virtual character to interact in a virtual scene, a first interaction image 401 is displayed, and first indication information 402 is displayed in a target region of the first interaction image 401. When the target account triggers the target region or the first indication information, a terminal receives a switching operation, and displays at least one candidate interaction team (i.e., candidate configuration state) 403 in the target region for selection by the target account.

Since the target region occupies only a partial region of the first interaction image, and has a particular transparency, displaying of the first indication information and displaying of each candidate configuration state do not obscure the first interaction image. In addition, each candidate configuration state is directly displayed in the current first interaction image, so that it is convenient for the target account to quickly select an appropriate configuration state from the current first interaction image. For state configuration and selection, the target account does not need to jump to a configuration interface that obscures the first interaction image. In this way, content (for example, the interaction process of the first virtual character in the virtual scene) displayed by the terminal does not leave the first interaction image (namely, does not leave a Big World HUD all the time). This can enhance immersion in the interaction process.

In actual application, after the current configuration state is switched to a target configuration state, indication information (i.e., second indication information) related to the target configuration state may still be displayed in a target region in a second interaction image. In addition, a size of the target region may be adjusted according to an amount of displayed content. For example, if the first indication information occupies a smaller space than at least one candidate configuration parameter, the first indication information is displayed in the target region with a first size. When receiving the switching operation, the terminal adjusts a display size of the target region in response to the switching operation. For example, the terminal adjusts the display size from the first size to a second size, and displays the at least one candidate configuration parameter in the target region with the second size. The first size is smaller than the second size. In this way, in the entire switching operation process, the terminal controls the display size of the target region to be adaptively adjusted according to a change in an occupation size of carried content, thereby improving harmony and aesthetic degree of displaying of the first interaction image.

Operation 103: Switch, in response to a selection operation performed on a target configuration state, the first interaction image to a second interaction image in which the target account corresponds to the target configuration state, and display second indication information of the target configuration state in the second interaction image.

Here, after the target account selects the target configuration state from the at least one candidate configuration state, in response to the selection operation, the terminal may perform switching from the first interaction image in which the target account corresponds to the current configuration state to the second interaction image in which the target account corresponds to the target configuration state, and display the second indication information of the target configuration state in the second interaction image. The second indication information is related information for indicating the target configuration state.

Next, a description is made with reference to different types of configuration states.

In some aspects, if the current configuration state includes the interaction team to which the first virtual character controlled by the target account belongs, the terminal may display, in the following manner in the first interaction image, first indication information that the target account corresponds to a current configuration state: displaying, in the first interaction image, a character identification of the first virtual character when the interaction team to which the first virtual character belongs includes one virtual character; when the interaction team to which the first virtual character belongs includes at least two virtual characters, displaying, in the first interaction image, character identifications of the virtual characters in the interaction team; and using the character identification as the first indication information that the target account corresponds to the current configuration state.

Here, when the interaction team includes only one virtual character (i.e., the first virtual character), the character identification (e.g., a character avatar, a character attribute, or a character feature) of the first virtual character is displayed in the first interaction image as the first indication information. When the interaction team includes a plurality of virtual characters (at least including the first virtual character), for example, when the interaction team includes one first virtual character and a plurality of other virtual characters (which are virtual characters controlled by another account different from the target account in the virtual scene), character identifications (e.g., character avatars, character attributes, or character features) of the first virtual character and each of the other virtual characters may be displayed in the first interaction image as the first indication information.

In some aspects, the terminal may display the at least one candidate configuration state in the first interaction image in the following manner: displaying at least one candidate interaction team in the first interaction image, and using each candidate interaction team as a candidate configuration state.

Here, when receiving the switching operation performed on an interaction team currently controlled by the target account, the terminal displays the at least one candidate interaction team in the first interaction image for selection and replacement by the target account.

In some aspects, by using the following manner, the terminal may switch, in response to a selection operation performed on a target configuration state, the first interaction image to a second interaction image in which the target account corresponds to the target configuration state, and display second indication information of the target configuration state in the second interaction image: switching, in response to a selection operation performed on a target interaction team among the at least one candidate interaction team, the first interaction image to the second interaction image of interaction performed, in the virtual scene, by a second virtual character in the target interaction team controlled by the target account; and displaying, in the second interaction image, a character identification of each virtual character in the target interaction team, to use the character identification of each virtual character in the target interaction team as the second indication information of the target configuration state.

Here, when the interaction team (referred to as an interaction team 1) to which the first virtual character currently controlled by the target account belongs includes only one virtual character (namely, the first virtual character), in response to the selection operation performed on the target interaction team, the interaction team controlled by the target account is switched from the interaction team 1 to the target interaction team. To be specific, controlling the first virtual character in the interaction team 1 to interact in the virtual scene is switched to controlling another virtual character in the target interaction team to interact in the virtual scene. The first virtual character is different from the another virtual character. The difference here is a difference in aspects such as an interaction ability, an interaction habit, and a proficient interaction skill (an example in which the virtual scene is a game is used, and a hero A and a hero B that have different proficient interaction skills belong to different virtual characters). After the switching succeeds, the first interaction image of interaction performed, in the virtual scene, by the first virtual character controlled by the target account is switched to the second interaction image in which the second virtual character in the target interaction team is controlled to interact in the virtual scene, and the character identifications (such as character avatars, character attributes, or character features) of the virtual characters (including the second virtual character and other virtual characters) in the target interaction team are displayed in the second interaction image as the second indication information.

When the interaction team (referred to as an interaction team 2) to which the first virtual character currently controlled by the target account belongs includes a plurality of virtual characters (for example, including one first virtual character and a plurality of other virtual characters), in response to the selection operation performed on the target interaction team, the interaction team controlled by the target account is switched from the interaction team 2 to the target interaction team. To be specific, controlling the first virtual character in the interaction team 2 to interact in the virtual scene is switched to controlling the second virtual character in the target interaction team to interact in the virtual scene. After the switching succeeds, the first interaction image of interaction performed, in the virtual scene, by the first virtual character controlled by the target account is switched to the second interaction image in which any virtual character in the target interaction team is controlled to interact in the virtual scene, and the character identifications (such as character avatars, character attributes, or character features) of the virtual characters in the target interaction team are displayed in the second interaction image as the second indication information.

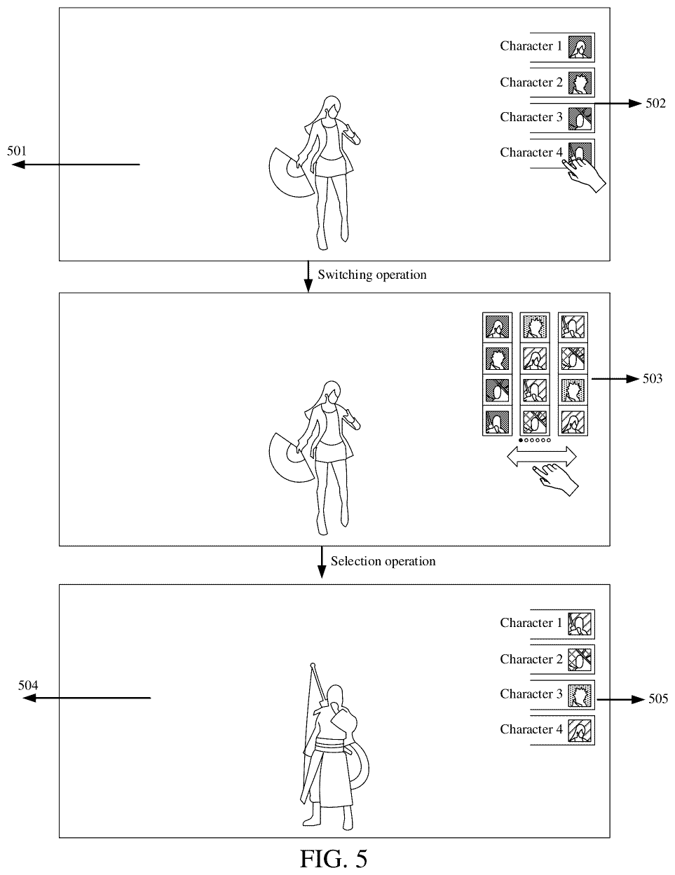

FIG. 5 is a schematic diagram of displaying of an interaction image according to an aspect described herein. If a current configuration state includes an interaction team to which a first virtual character belongs (it is assumed that the first virtual character belongs to an interaction team 1), in a process of controlling, by a target account, the first virtual character in the interaction team 1 to interact in a virtual scene, a character list corresponding to the interaction team 1 is displayed in a first interaction image 501. The character list displays avatars of virtual characters (there may be a plurality of virtual characters, for example, a character 1, a character 2, a character 3, and a character 4) in the interaction team 1 as first indication information 502. When the target account triggers the character list, a terminal receives a switching operation, and displays a team list 503. At least one candidate interaction team, for example, a candidate interaction team 1, a candidate interaction team 2, and a candidate interaction team 3, is displayed in the team list 503. In response to a selection operation performed on a target interaction team (for example, the candidate interaction team 2), the first interaction image 501 is switched to a second interaction image 504 in which any virtual character (for example, a second virtual character) in the target interaction team is controlled to interact in the virtual scene, and the character list corresponding to the target interaction team is displayed in the second interaction image 504. The character identifications (there may be a plurality of character identifications, such as avatars of the character 1, the character 2, and the character 3) of the virtual characters in the target interaction team are displayed in the character list as the second indication information 505.

Here, after the interaction team switching is performed, a quantity of the virtual characters in the target interaction team may be the same as or different from a quantity of virtual characters in an interaction team (that is, the interaction team to which the first virtual character belongs) controlled by the target account before switching. For example, before switching, the interaction team 1 to which the first virtual character controlled by the target account belongs includes three virtual characters, and after switching, the quantity of the virtual characters included in the target interaction team to which the second virtual character controlled by the target account belongs may be three, or may be another quantity (for example, four).

In some aspects, the terminal may display the at least one candidate interaction team in the first interaction image in the following manner: displaying, when a quantity of the candidate interaction teams is at least two, the candidate interaction teams in a form of a team list in the first interaction image; or, displaying the candidate interaction teams in the first interaction image in a scrolling manner.

As shown in FIG. 5, when there are a plurality of (two or more) candidate interaction teams, the candidate interaction teams may be displayed in a form of a team list 503 in the first interaction image. When there are a large quantity of candidate interaction teams, and a display region for displaying the candidate interaction teams is not large enough to display all the candidate interaction teams at a time, some candidate interaction teams may be displayed at a time, and other candidate interaction teams may be displayed in a switching manner by swiping the team list left and right.

In addition, the terminal may further display the candidate interaction teams in the first interaction image in the scrolling manner. A scrolling cycle is related to the quantity of the candidate interaction teams, a size of a display region occupied by each candidate interaction team, a size of a total display region for displaying the candidate interaction teams, and the like.

In the above manner, sufficient candidate interaction teams may be displayed in a limited display region of the first interaction image for selection by a player, thereby improving a utilization rate of the display region.

In some aspects, the terminal may display the at least one candidate interaction team in the first interaction image in the following manner: obtaining, when a quantity of the candidate interaction teams is at least two, an impact parameter for affecting selection priorities of the candidate interaction teams, the impact parameter including at least one of the following: interaction attributes of the candidate interaction teams, character features of virtual characters included in the candidate interaction teams, and historical interaction features of the candidate interaction teams; and determining the selection priorities of the candidate interaction teams based on the impact parameter, and displaying, in the first interaction image, the candidate interaction teams in display styles corresponding to the selection priorities.

Here, when there are at least two candidate interaction teams, display priorities corresponding to different candidate interaction teams may be different. The candidate interaction teams may be displayed in the corresponding display styles according to the display priorities corresponding to the candidate interaction teams. To be specific, for the candidate interaction teams with different display priorities, the candidate interaction teams are displayed in different display styles (for example, different display sequences, different display colors, different display brightness, or different display fonts), or candidate interaction teams with relatively high display priorities are highlighted. For example, there are three candidate interaction teams for selection, namely, candidate interaction team 1, a candidate interaction team 2, and a candidate interaction team 3. Display priorities corresponding to the three candidate interaction teams sequentially decrease. The candidate interaction team 1 may be displayed in a red font, the candidate interaction team 2 may be displayed in a yellow font, and the candidate interaction team 3 may be displayed in a gray font, so that it is convenient for a user to select a desired candidate interaction team, thereby helping improve pertinence of team switching and switching efficiency.

During actual implementation, the display priorities of the candidate interaction teams may be determined through the following processing: obtaining the impact parameter for influencing the selection priorities of the candidate interaction teams, and invoking a neural network model to perform display priority prediction based on the impact parameter, to obtain the display priorities of the candidate interaction teams. The neural network model is obtained through training by using a team sample, an impact parameter corresponding to the team sample, and a display priority marked by the team sample.

An example in which the virtual scene is a game is used. An interaction attribute of a candidate interaction team may be a type and a function tendency of the interaction team, for example, whether the interaction team is good at attacking or defending, or whether the interaction team is a damage-enhanced team or a compression-resistant team. A character feature of a virtual character included in a candidate interaction team may be a feature such as a composition configuration of the virtual character, a virtual character type (for example, whether the virtual character is an attacking game character or a defending game character), a level of a game character, or a proficient skill of a game character. A historical interaction feature of a candidate interaction team means a number of times of historically selecting the candidate interaction team by the target account or another account different from the target account, or an interaction result (such as a fight score or a fight win rate), in the game, of controlling, by the target account or another account different from the target account, the selected candidate interaction team after the switching of the candidate interaction team. After the impact parameter for affecting the selection priorities of the candidate interaction teams is obtained, the impact parameter is predicted in the trained neural network model to obtain the display priorities of the candidate interaction teams. This can make the prediction more accurate.

Before the neural network model is applied, an initial neural network model needs to be trained, and then the trained neural network model is put into use, to predict the display priorities of the candidate interaction teams through an artificial intelligence technology with reference to the impact parameter. The neural network model is obtained through training by using a team sample, an impact parameter corresponding to the team sample, and a display priority marked by the team sample. For example, the initial neural network model is invoked for prediction based on the team sample, a historical interaction feature associated with the team sample, and the display priority marked by the team sample, to obtain a predicted display priority. After a value of a loss function of the neural network model is determined through the predicted display priority and the marked display priority, whether the value of the loss function exceeds a preset threshold may be determined. When the value of the loss function exceeds the preset threshold, an error signal of the neural network model is determined based on the loss function, and the error signal is back-propagated in the neural network model; and a model parameter of each layer is updated in the propagation process.

A model structure of the neural network model is not limited in this aspect described herein. For example, the neural network model may be a convolutional neural network, a deep neural network, or the like. A form of the loss function is not limited either. For example, the loss function may be a cross entropy loss function, an L2 loss function, or the like.

The back-propagation is described herein. Training sample data is inputted to an input layer of the neural network model. The data passes through a hidden layer and finally reaches an output layer, and a result is outputted. This is a forward-propagation process of the neural network model. Since there is an error between an outputted result of the neural network model and an actual result, an error between the outputted result and an actual value is calculated, and the error is back-propagated from the output layer to the hidden layer until the error is propagated to the input layer. In the back-propagation process, a value of the model parameter is adjusted based on the error. That is, the loss function is constructed according to the error between the outputted result and the actual value, and partial derivatives of the loss function for the model parameter are calculated layer by layer, to generate a gradient of the loss function for the model parameter of each layer. Since a direction of the gradient indicates an error expansion direction, the gradient for the model parameter is negated for summation with an original model parameter of each layer. An obtained summation result is used as an updated model parameter of each layer, thus reducing the error caused by the model parameter. The above process is continuously iterated until convergence occurs.

In some aspects, after displaying the at least one candidate interaction team in the first interaction image, the terminal may further display, in a display region of each candidate interaction team, a character identification of at least one virtual character included in the corresponding candidate interaction team, or display, in a display region of each candidate interaction team, a team attribute identification of each candidate interaction team.

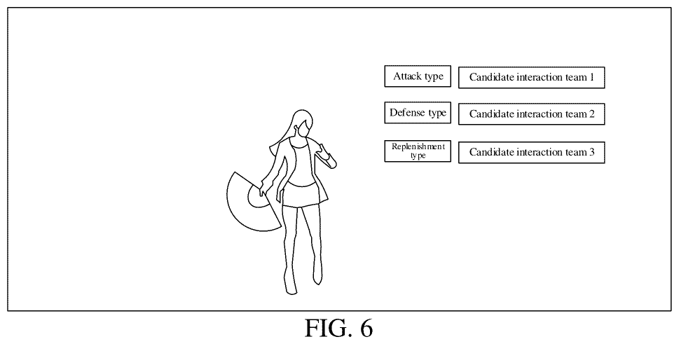

For example, as shown in FIG. 5, when displaying a candidate interaction team, the terminal displays, in a display region of the candidate interaction team, avatars of all virtual characters included as character identifications. Or, FIG. 6 is a schematic diagram of displaying of candidate interaction teams according to an aspect described herein. Team attribute identifications of the candidate interaction teams are displayed in display regions of the candidate interaction teams, to indicate types and function tendencies of the candidate interaction teams. For example, for a candidate interaction team of an attack type, a team attribute identification corresponding to the attack type is displayed. For a candidate interaction team of a defense type, a team attribute identification corresponding to the defense type is displayed. In this way, it is convenient for a user to select a desired candidate interaction team, thereby helping improve pertinence of team switching and switching efficiency.

In some aspects, before displaying the at least one candidate interaction team in the first interaction image, the terminal may configure each candidate interaction team in the following manner: displaying a team configuration interface, and displaying an interaction team template on the team configuration interface, the interaction team template including a plurality of bearing positions for bearing virtual characters; displaying added virtual characters at the bearing positions in the interaction team template in response to a character adding operation; and generating, in response to a team generation operation, a candidate interaction team including the added virtual characters.

Here, to facilitate switching of interaction teams, one or more candidate interaction teams suitable for the target account may be configured in advance for selection by the target account. For example, candidate interaction teams having different function tendencies may be configured in advance according to an actual need. During the configuration of the candidate interaction teams, the interaction team template may be selected on the team configuration interface. The interaction team template includes the plurality of bearing positions. The corresponding virtual characters are added to the bearing positions in the interaction team template based on the interaction team template. If the interaction team template includes four bearing positions, four virtual characters are added to the bearing positions in the interaction team template, to generate the candidate interaction teams corresponding to the interaction team template.

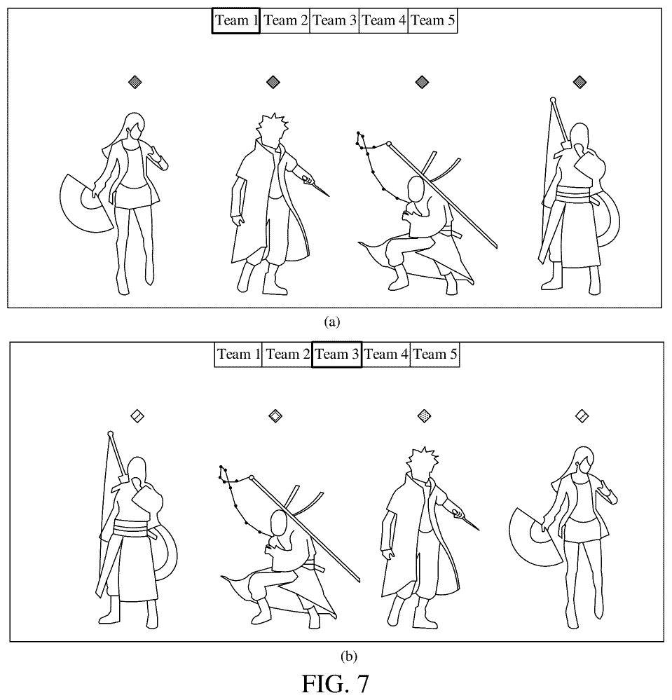

FIG. 7 is a schematic diagram of configuration of candidate interaction teams according to an aspect described herein. The target account configures, according to an actual need, candidate interaction teams having different functional tendencies in advance. After the configuration is completed, the configured candidate interaction teams, such as a team 1 to a team 5, may be displayed on the team configuration interface. Names of the candidate interaction teams are displayed on the team configuration interface. Details of the corresponding candidate interaction teams may be viewed by triggering the names of the candidate interaction teams. As shown in FIG. 7(a), when a user taps “Team 1”, detailed information of a plurality of virtual characters included in the team 1 is displayed on the team configuration interface. As shown in FIG. 7(b), when a user taps “Team 3”, detailed information of a plurality of virtual characters included in the team 3 is displayed on the team configuration interface.

In the above manner, a player configures candidate interaction teams suitable for the player in advance, so as to select a target interaction team from the candidate interaction teams that are already configured and that are suitable for the player during switching of interaction teams, thereby helping improve pertinence of team switching and switching efficiency.

In some aspects, before displaying the added virtual characters at the bearing positions in the interaction team template, the terminal may receive the character adding operation in the following manner: displaying, in the interaction team template, first adding controls for adding virtual characters, the first adding controls and the bearing positions being in a one-to-one correspondence; displaying at least two candidate virtual characters for selection in response to a trigger operation performed on a first adding control corresponding to a target bearing position; and receiving, in response to a selection operation performed on a target virtual character, a character adding operation performed on the target bearing position, the character adding operation instructing the target virtual character to be added to the target bearing position.

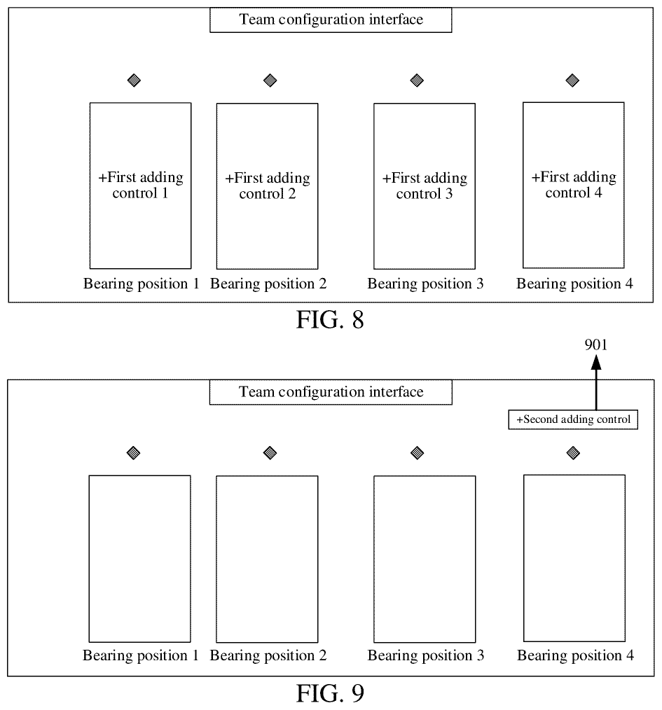

FIG. 8 is a schematic diagram of configuration of a candidate interaction team according to an aspect described herein. When there are a plurality of bearing positions, a corresponding first adding control is displayed at an associated position of each bearing position. To be specific, the bearing positions and the first adding controls are in a one-to-one correspondence, and one bearing position corresponds to one first adding control. An example in which an interaction team template includes four bearing positions is used. A first adding control 1 is displayed at an associated position of a bearing position 1. A first adding control 2 is displayed at an associated position of a bearing position 2. A first adding control 3 is displayed at an associated position of a bearing position 3. A first adding control 4 is displayed at an associated position of a bearing position 4. A user may add a virtual character to a target bearing position through the first adding control corresponding to the target bearing position. For example, in response to a trigger operation performed on the first adding control 1, at least two candidate virtual characters for selection are displayed. In response to a selection operation performed on a target virtual character, the target virtual character is added to the bearing position 1. In the above manner, the corresponding virtual characters may be added to the bearing positions. In this way, the user can conveniently add a desired virtual character to a bearing position according to an actual need, thereby improving flexibility of team configuration.

In addition, character adding prompt information may further be displayed while the first adding controls are displayed at the associated positions of the bearing positions, for example, prompting adding a virtual character having a particular skill to a bearing position. In this way, the user may add an appropriate virtual character to the bearing position according to the prompt information. After the appropriate virtual characters are added to all the bearing positions, a candidate interaction team in which the virtual characters cooperate with each other to complete an interaction purpose can be formed, thereby improving effectiveness of configuration of an interaction team.

In some aspects, the terminal may display the selected virtual characters at the bearing positions in the interaction team template in response to the character adding operation in the following manner: displaying, in the interaction team template, a second adding control for adding a virtual character, the second adding control corresponding to the plurality of bearing positions; and displaying at least two candidate virtual characters for selection in response to a trigger operation performed on the second adding control; and displaying, in response to a character adding operation performed on a target quantity of candidate virtual characters, a target virtual character among the target quantity of candidate virtual characters at the bearing positions in the interaction team template, an adaptation degree between the target virtual character displayed at the bearing positions and the corresponding bearing positions exceeding an adaptation degree threshold.

FIG. 9 is a schematic diagram of configuration of a candidate interaction team according to an aspect described herein. When there are a plurality of bearing positions, a second adding control jointly corresponding to all the bearing positions is displayed in an interaction team template (to be specific, the bearing positions and the second adding control are in a multiple-to-one correspondence, and one second adding control corresponds to the plurality of bearing positions). The example in which the interaction team template includes four bearing positions is still used. A second adding control 901 corresponds to a bearing position 1 to a bearing position 4. When a user triggers the second adding control 901, the terminal displays at least two candidate virtual characters for selection in response to the trigger operation. After the user may select a target quantity (which is consistent with a quantity of the bearing positions in the target interaction template. For example, if there are four bearing positions, the target quantity is four) of virtual characters therefrom, the terminal automatically adds target virtual characters among the target quantity of (namely, four) virtual characters to the matching bearing positions in the interaction team template in response to the character adding operation.

An example in which a target virtual character is added to one bearing position is used. To add a target virtual character to a bearing position, the terminal may calculate adaptation degrees (for example, calculate a similarity value) between a bearing position feature (for example, a character feature of a to-be-added virtual character) corresponding to the bearing position and character features of the selected virtual characters, to obtain corresponding adaptation degrees, and add a target virtual character with the adaptation degree exceeding an adaptation degree threshold to the bearing position. In the above manner, the matching target virtual character may be added to each bearing position. For example, if the bearing position 1 requires a virtual character that outputs an ultimate attack, a virtual character 1 that is good at outputting an ultimate attack is added to the bearing position 1. For another example, if the bearing position 4 requires a replenishing virtual character, a replenishing virtual character 2 is added to the bearing position 4. The rest can be deduced by analogy. The virtual character in each bearing position is a virtual character that is most needed by the bearing position. To be specific, the target virtual character added to each bearing position is a virtual character that is among the target quantity of virtual characters and that has a highest adaptation degree to the bearing position. In this way, a candidate interaction team in which a plurality of virtual characters best cooperate with each other and match each other may be obtained, thereby improving effectiveness of configuration of an interaction team.

Here, in actual application, after the target account has selected the target quantity of virtual characters, the target quantity of virtual characters may further be manually dragged to the matching bearing positions. In this way, a candidate interaction team in which a plurality of virtual characters best cooperate with each other and match each other may be obtained, thereby improving flexibility, pertinence, and effectiveness of configuration of an interaction team.

In some aspects, the terminal may display the selected virtual characters at the bearing positions in the interaction team template in response to the character adding operation in the following manner: displaying, in the interaction team template, a third adding control for adding a virtual character, the third adding control corresponding to the plurality of bearing positions; displaying at least two candidate virtual characters for selection in response to a trigger operation performed on the third adding control; and displaying, in response to a dragging operation performed on a target virtual character, the target virtual character at a bearing position indicated by the dragging operation in the interaction team template.

In actual application, when there are a plurality of bearing positions, the third adding control jointly corresponding to all the bearing positions is displayed in the interaction team template (to be specific, the bearing positions and the third adding control are in a multiple-to-one correspondence, and one third adding control corresponds to the plurality of bearing positions). In response to a trigger operation performed on the third adding control, a plurality of candidate virtual characters for selection are displayed. A player may drag a selected target virtual character to a corresponding bearing position, to configure the target virtual character in the bearing position indicated by dragging. The example in which the interaction team template includes four bearing positions is still used. The third adding control corresponds to a bearing position 1 to a bearing position 4. When a user triggers the third adding control, the terminal displays at least two candidate virtual characters for selection in response to the trigger operation, such as a candidate virtual character 1 to a candidate virtual character 5. When the user drags the candidate virtual character 1 to the bearing position 4, the candidate virtual character may be configured in the bearing position 4. In this manner, the virtual characters in the bearing positions in the interaction team template may be configured, thereby improving flexibility and pertinence of configuration of an interaction team.

In some aspects, if the current configuration state includes the equipment set used for interaction by the first virtual character, by using the following manner, the terminal may display, in the first interaction image, first indication information that the target account corresponds to a current configuration state: displaying, in the first interaction image, equipment identifications of types of virtual equipment in the equipment set used for interaction by the first virtual character; and using the equipment identifications of the types of virtual equipment as the first indication information that the target account corresponds to the current configuration state.

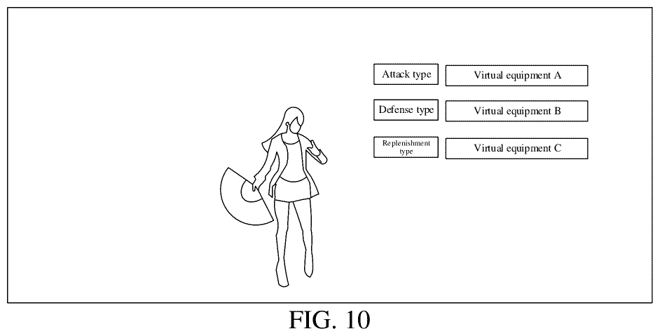

FIG. 10 is a schematic diagram of displaying of indication information according to an aspect described herein. If a current configuration state includes an equipment set used for interaction by a first virtual character, equipment identifications of virtual equipment in an equipment set 1 may be displayed in a target region of a first interaction image. It is assumed that the equipment set used for interaction by the first virtual character is the equipment set 1, and the equipment set 1 includes attack-type virtual equipment A, defense-type virtual equipment B, replenishment-type virtual equipment C, and hiding-type virtual equipment D. Equipment identifications respectively corresponding to the attack-type virtual equipment A, the defense-type virtual equipment B, the replenishment-type virtual equipment C, and the hiding-type virtual equipment D are used as first indication information that a target account corresponds to the current configuration state.

In addition, a set identification corresponding to the equipment set used for interaction by the first virtual character may be further displayed. The set identification reflects a comprehensive function tendency of the equipment set, such as focusing on attacking or defending, and the set identification is used as the first indication information that the target account corresponds to the current configuration state.

In some aspects, the terminal may display the at least one candidate configuration state in the first interaction image in the following manner: displaying at least one candidate equipment set in the first interaction image, and using a candidate equipment state as the candidate configuration state.

Here, when receiving a switching operation performed on an equipment set currently equipped on the first virtual character, the terminal displays the at least one candidate equipment set in the first interaction image for selection and replacement by the target account.

In some aspects, by using the following manner, the terminal may switch, in response to a selection operation performed on a target configuration state, the first interaction image to a second interaction image in which the target account corresponds to the target configuration state, and display second indication information of the target configuration state in the second interaction image: switching, in response to a selection operation performed on a target equipment set among the at least one candidate equipment set, the first interaction image to the second interaction image of interaction performed, in the virtual scene, by the first virtual character by using the target equipment set; and displaying, in the second interaction image, an equipment identification of virtual equipment included in the target equipment set, to use the equipment identification of the virtual equipment included in the target equipment set as the second indication information of the target configuration state.

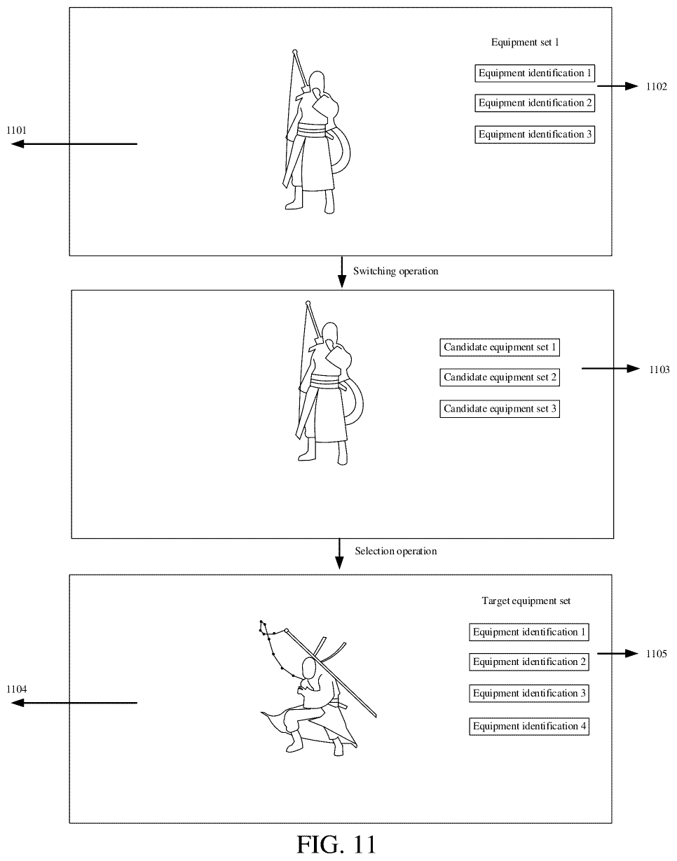

FIG. 11 is a schematic diagram of displaying of an interaction image according to an aspect described herein. If a current configuration state includes an equipment set used for interaction by a first virtual character (it is assumed that the equipment set currently used for interaction by the first virtual character is an equipment set 1), in a process of controlling the first virtual character equipped with the equipment set 1 to interact in a virtual scene, a target account displays first indication information 1102 in a target region of a first interaction image 1101, for example, equipment identifications (such as icons of virtual equipment) of virtual equipment in the equipment set 1. When the target account triggers the target region or the first indication information, the terminal receives a switching operation, displays at least one candidate equipment set 1103, such as a candidate equipment set 1, a candidate equipment set 2, and a candidate equipment set 3, in the target region, switches, in response to a selection operation performed on a target equipment set (such as the candidate equipment set 2), the first interaction image 1101 of interaction performed, in the virtual scene, by the first virtual character equipped with the equipment set 1 to a second interaction image 1104 of interaction performed, in the virtual scene, by the first virtual character equipped with the target equipment set (namely, the candidate equipment sct 2), and displays equipment identifications of virtual equipment (for example, icons of the virtual equipment) in the target equipment set (namely, the candidate equipment set 2) in the second interaction image 1104 as second indication information 1105.

When there is a plurality of (two or more) candidate equipment sets, the candidate equipment sets may be displayed in parallel in a target region of the first interaction image. When there is a large quantity of candidate equipment sets, and a target region for displaying the candidate equipment sets is not large enough to display all the candidate equipment sets at a time, some candidate equipment sets may be displayed at a time, and other candidate equipment sets may be displayed in a switching manner by swiping left and right. In addition, the terminal may further display the candidate equipment sets in the first interaction image in a scrolling manner. A scrolling cycle is related to the quantity of the candidate equipment sets, a size of a display region occupied by each candidate equipment set, a size of a total display region for displaying the candidate equipment sets, and the like. In the above manner, sufficient candidate equipment sets may be displayed in a limited display region of the first interaction image for selection by a player, thereby improving a utilization rate of the display region.

Furthermore, when there are at least two candidate equipment sets, display priorities corresponding to different candidate equipment sets may be different. The candidate equipment sets may be displayed in the corresponding display styles according to the display priorities corresponding to the candidate equipment sets. To be specific, for the candidate equipment sets with different display priorities, the candidate equipment sets are displayed in different display styles (for example, different display sequences, different display colors, different display brightness, or different display fonts), or candidate equipment sets with relatively high display priorities are highlighted. It is convenient for a user to select a desired candidate equipment set, thereby helping improve pertinence of equipment switching and switching efficiency.

In actual application, display priorities of the candidate equipment sets may be determined through the following processing: obtaining an impact parameter for affecting selection priorities of the candidate equipment sets, such as function attributes of the candidate equipment sets (for example, whether a candidate equipment set focuses on attacking or defending) and equipment features of virtual equipment in the candidate equipment sets (such as types of the virtual equipment and equipment composition configurations); and after obtaining the impact parameter, invoking a neural network model to perform display priority prediction based on the impact parameter, to obtain the display priorities of the candidate equipment sets. This makes the prediction more accurate. The neural network model is obtained through training by using a set sample, an impact parameter corresponding to the set sample, and a display priority marked by the set sample.

In some aspects, before displaying the at least one candidate equipment set in the first interaction image, the terminal may configure each candidate equipment set in the following manner: displaying an equipment configuration interface, and displaying, on the equipment configuration interface, an equipment adding control for adding virtual equipment; displaying a target quantity of added virtual equipment in response to an equipment adding operation that is triggered based on the equipment adding control; and generating, in response to an equipment set generation operation, the candidate equipment set including the target quantity of virtual equipment.

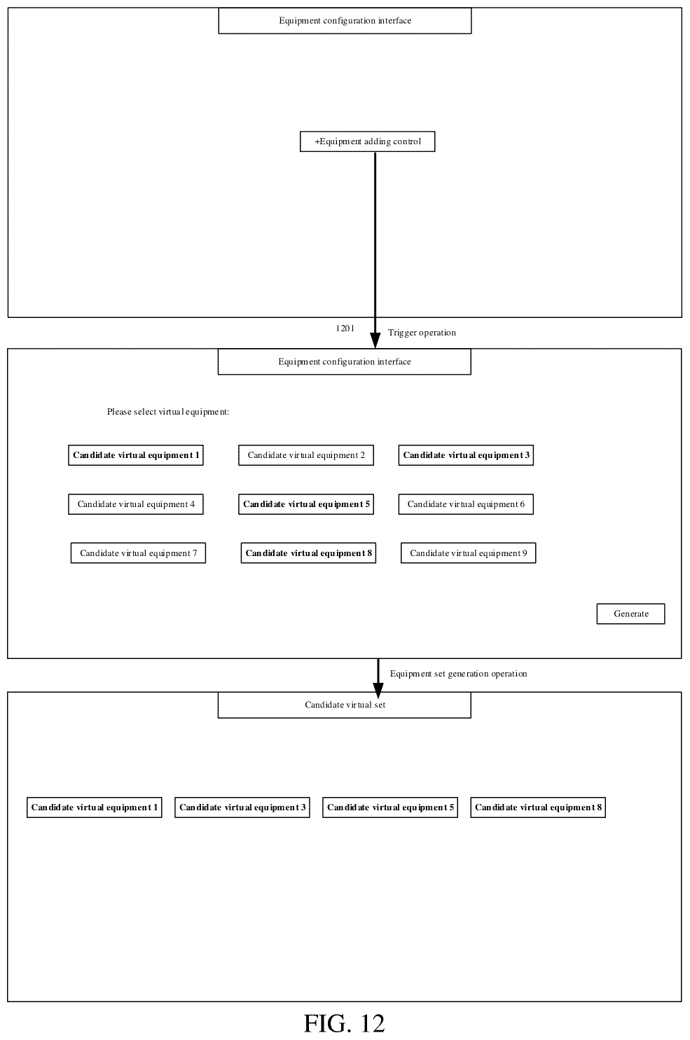

FIG. 12 is a schematic diagram of configuration of a candidate equipment set according to an aspect described herein. When there is a plurality of virtual equipment required by the candidate equipment set, an equipment adding control 1201 for adding virtual equipment is displayed on an equipment configuration interface. When a user triggers the equipment adding control 1201, a terminal displays at least two sets of candidate virtual equipment for selection in response to the trigger operation. The user can select a target quantity of virtual equipment therefrom. The terminal receives an equipment adding operation, and displays, in response to the equipment adding operation, the target quantity of sets of selected virtual equipment. After the user taps a generation button, the terminal receives an equipment set generation operation, and generates, in response to the equipment set generation operation, a candidate equipment set including the target quantity of virtual equipment.

In addition, while displaying the equipment adding control, equipment adding prompt information may further be displayed, for example, prompting adding virtual equipment having a particular skill (such as a virtual prop or a virtual skill). In this way, a user may select appropriate virtual equipment according to the equipment adding prompt information. After a particular quantity of virtual equipment is selected, a candidate equipment set including various types of virtual equipment may be formed, thereby improving effectiveness of equipment set configuration.

In the above manner, in a process in which a target account controls a first virtual object to interact in a virtual scene, first indication information that the target account corresponds to a current configuration state is displayed in a first interaction image of the first virtual object. If a switching operation performed on the current configuration state is triggered, candidate configuration state for selections are displayed in the first interaction image. After a target configuration state is selected from the candidate configuration states, the first interaction image currently displayed by a terminal is switched to a second interaction image in which the target account corresponds to the target configuration state, thereby implementing configuration state switching. In the switching process, displaying of the candidate configuration states and selection of the target configuration state are both directly implemented in the first interaction image. To be specific, the first interaction image is always displayed on a view interface of the terminal in the switching process, thereby avoiding interruption of the first interaction image, and enhancing immersion and experience in an interaction process.

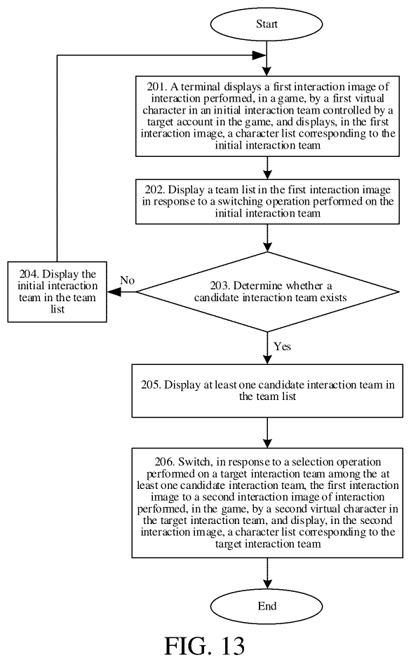

The following will describe illustrative application of this aspect described herein in an actual application scene. An example in which a virtual scene is a game and a current configuration state includes an interaction team to which a first virtual character controlled by a target account belongs, the method for interaction in a virtual scene according to the aspects described herein will be further explained. FIG. 13 is a flowchart of a method for interaction in a virtual scene according to an aspect described herein. The method includes the following operations:

Operation 201: A terminal displays a first interaction image of interaction performed, in a game, by a first virtual character in an initial interaction team controlled by a target account in the game, and displays, in the first interaction image, a character list corresponding to the initial interaction team.

The initial interaction team is an interaction team currently controlled by the target account (an account corresponding to a player). The initial interaction team includes a plurality of virtual characters. The first virtual character that currently interacts in the game may be any virtual character in the initial interaction team. The first interaction image is a current Big World HUD in the game, a main user interface that always floats on a game image in a gaming process, or is a hot zone in which players perform interaction behaviors. The character list may be displayed in a target region in the first interaction image. The target region is a partial region in the first interaction image and is configured for displaying the character list (namely, the above first indication information) corresponding to the initial interaction team. For example, character identifications (such as character avatars, character attributes, or character features) of virtual characters in the initial interaction team are displayed in the character list.

Operation 202: Display a team list in the first interaction image in response to a switching operation performed on the initial interaction team.

In actual application, the switching operation may be triggered by a user by triggering the target region or the character list. For example, when a player triggers (for example, touches and holds) the character list, the terminal receives the switching operation performed on the initial interaction team, and displays the team list in the first interaction image in response to the switching operation. The team list may alternatively be displayed in the above target region. In this way, a preset team list may be called out by triggering the character list, and a repeated jump operation does not need to be performed.

The team list is configured for displaying an interaction team corresponding to the target account. When the interaction team is displayed in the team list, character identifications of virtual characters included in the interaction team may be displayed in the form of a character list. For example, when the initial interaction team is displayed in the team list and the initial interaction team includes four virtual characters, a character list of the initial interaction team may be displayed in the team list, namely, the character identifications of the virtual characters in the initial interaction team may be displayed in the form of a character list.

Operation 203: Determine whether a candidate interaction team exists.

The candidate interaction team is an interaction team configured by a player in advance according to an actual need. During the configuration of an interaction team, a plurality of candidate interaction teams with different function tendencies may be configured according to an actual need, for selection and use during switching.

The candidate interaction team here does not include the initial interaction team currently controlled by the target account. When no candidate interaction team exists, operation 204 is performed. When a candidate interaction team exists, operation 205 is performed.

Operation 204: Display the initial interaction team in the team list.

Here, when the target account does not configure a candidate interaction team in advance, only the current initial interaction team may be displayed in the team list.

Operation 205: Display at least one candidate interaction team in the team list.

Here, when the target account has configured a candidate interaction team in advance, the candidate interaction team that is configured in advance is displayed in the team list. When there are a large number of candidate interaction teams, some candidate interaction teams may be displayed in the team list at a time, and other candidate interaction teams may be displayed in a switching manner by swiping the team list left and right.

In addition, since the candidate interaction team displayed in the team list is configured by the player in advance, the player may switch and select a team quickly in existing knowledge, without consuming any cognitive costs.

Operation 206: Switch, in response to a selection operation performed on a target interaction team among the at least one candidate interaction team, the first interaction image to a second interaction image of interaction performed, in the game, by a second virtual character in the target interaction team, and display, in the second interaction image, a character list corresponding to the target interaction team.

Here, when a user selects the target interaction team from the candidate interaction teams, the terminal switches, in response to the selection operation, an interaction team controlled by the target account from the initial interaction team to the target interaction team. To be specific, controlling the first virtual character in the initial interaction team to interact in the game is switched to controlling the second virtual character (any virtual character in the target interaction team) in the target interaction team to interact in the game. After the switching succeeds, the first interaction image of interaction performed, in the game, by the first virtual character in the initial interaction team is switched to the second interaction image of interaction performed, in the game, by the second virtual character in the target interaction team, and character identifications (such as character avatars, character attributes, or character features) of virtual characters in the target interaction team are displayed in the character list in the second interaction image, namely, the above second indication information.

Similarly, the character list displayed in the second interaction image may alternatively be displayed in the target region. Since the character list, the team list, or the target region occupies only a partial region of the interaction image, displaying of the character list and the team list does not obscure the interaction image. In addition, since the candidate interaction teams are directly displayed in a current interaction image, it is convenient for a player to quickly select an appropriate interaction team from the candidate interaction teams, and does not need to jump to a configuration interface that obscures the current interaction image for team configuration and selection. In this way, content displayed on the terminal does not always leave a Big World HUD. To be specific, a current team configuration can be quickly switched without leaving the Big World HUD, thereby reducing operation interruption and enhancing immersion of the player in Big World, shortening time spent by the player in switching teams, and improving team switching efficiency and a game experience of the player.

To this end, the method for interaction in the virtual scene according to the aspects described herein has been explained in conjunction with the illustrative applications and implementations of the electronic device according to the aspects described herein. The following continues to explain cooperation of modules in an apparatus 555 for interaction in a virtual scene according to the aspects described herein to implement a virtual object control solution.

A first display module 5551 is configured to: display a first interaction image of interaction performed, in the virtual scene, by a first virtual character controlled by a target account, and display, in the first interaction image, first indication information that the target account corresponds to a current configuration state, the current configuration state including at least one of the following: an interaction team to which the first virtual character controlled by the target account belongs, and an equipment set used for interaction by the first virtual character, the interaction team including at least one virtual character, and the equipment set including at least two types of virtual equipment. A second display module 5552 is configured to display at least one candidate configuration state in the first interaction image in response to a switching operation performed on the current configuration state. A third display module 5553 is configured to: switch, in response to a selection operation performed on a target configuration state, the first interaction image to a second interaction image in which the target account corresponds to the target configuration state, and display second indication information of the target configuration state in the second interaction image.

In some aspects, the first display module is further configured to display, in a target region having a preset transparency in the first interaction image, the first indication information that the target account corresponds to the current configuration state, where the target region is a partial region of the first interaction image. Correspondingly, the second display module is further configured to display the at least one candidate configuration state in the target region of the first interaction image.

In some aspects, before displaying the at least one candidate configuration state in the first interaction image, the apparatus further includes: an operation receiving module, configured to receive, in one of the following manners, a switching operation performed on the current configuration state: receive a first trigger operation performed on the first indication information, and use the first trigger operation as the switching operation performed on the current configuration state; receive a second trigger operation performed on a switch control for switching the current configuration state, and use the second trigger operation as the switching operation performed on the current configuration state; display prompt information for prompting switching of a configuration state, and determine, when a confirming operation performed on the prompt information is received, that the confirming operation is the switching operation performed on the current configuration state; and display a display duration of the first indication information, and receive the switching operation performed on the current configuration state when the display duration reaches a target duration.

In some aspects, when the current configuration state includes the interaction team to which the first virtual character controlled by the target account belongs, the first display module is further configured to: display, in the first interaction image, a character identification of the first virtual character when the interaction team to which the first virtual character belongs includes one virtual character; when the interaction team to which the first virtual character belongs includes at least two virtual characters, display, in the first interaction image, character identifications of the virtual characters in the interaction team; and use the character identification as the first indication information that the target account corresponds to the current configuration state.

In some aspects, the second display module is further configured to: display at least one candidate interaction team in the first interaction image, and use each candidate interaction team as a candidate configuration state.

In some aspects, the second display module is further configured to: display, when a quantity of the candidate interaction teams is at least two, the candidate interaction teams in a form of a team list in the first interaction image; or, display the candidate interaction teams in the first interaction image in a scrolling manner.

In some aspects, the second display module is further configured to: obtain, when a quantity of the candidate interaction teams is at least two, an impact parameter for affecting selection priorities of the candidate interaction teams, the impact parameter including at least one of the following: interaction attributes of the candidate interaction teams, character features of virtual characters included in the candidate interaction teams, and historical interaction features of the candidate interaction teams; and determine the selection priorities of the candidate interaction teams based on the impact parameter, and display, in the first interaction image, the candidate interaction teams in display styles corresponding to the selection priorities.

In some aspects, after displaying the at least one candidate interaction team in the first interaction image, the apparatus further includes: a third display module, configured to: display, in a display region of each candidate interaction team, a character identification of at least one virtual character included in the corresponding candidate interaction team; or display a team attribute identification of each candidate interaction team in a display region of each candidate interaction team.

In some aspects, the third display module is further configured to: switch, in response to a selection operation performed on a target interaction team among the at least one candidate interaction team, the first interaction image to the second interaction image of interaction performed, in the virtual scene, by a second virtual character in the target interaction team controlled by the target account; and display, in the second interaction image, a character identification of each virtual character in the target interaction team, to use the character identification of each virtual character in the target interaction team as the second indication information of the target configuration state.

In some aspects, before displaying the at least one candidate interaction team in the first interaction image, the apparatus further includes: a team configuration module, configured to configure each candidate interaction team in the following manner: displaying a team configuration interface, and displaying an interaction team template on the team configuration interface, the interaction team template including a plurality of bearing positions for bearing virtual characters; displaying added virtual characters at the bearing positions in the interaction team template in response to a character adding operation; and generating, in response to a team generation operation, a candidate interaction team including the added virtual characters.

In some aspects, before displaying the added virtual characters at the bearing positions in the interaction team template, the apparatus further includes: an adding receiving module, configured to: display, in the interaction team template, first adding controls for adding virtual characters, the first adding controls and the bearing positions being in a one-to-onc correspondence; display at least two candidate virtual characters for selection in response to a trigger operation performed on a first adding control corresponding to a target bearing position; and receive, in response to a selection operation performed on a target virtual character, a character adding operation performed on the target bearing position, the character adding operation instructing the target virtual character to be added to the target bearing position.

In some aspects, the team configuration module is further configured to: display, in the interaction team template, a second adding control for adding a virtual character, the second adding control corresponding to the plurality of bearing positions; display at least two candidate virtual characters for selection in response to a trigger operation performed on the second adding control; and display, in response to a character adding operation performed on a target quantity of candidate virtual characters, a target virtual character among the target quantity of candidate virtual characters at the bearing positions in the interaction team template, an adaptation degree between the target virtual character displayed at the bearing positions and the corresponding bearing positions exceeding an adaptation degree threshold.

In some aspects, the team configuration module is further configured to: display, in the interaction team template, a third adding control for adding a virtual character, the third adding control corresponding to the plurality of bearing positions; display at least two candidate virtual characters for selection in response to a trigger operation performed on the third adding control; and display, in response to a dragging operation performed on a target virtual character, the target virtual character at a bearing position indicated by the dragging operation in the interaction team template.

In some aspects, when the current configuration state includes the equipment set used for interaction by the first virtual character, the first display module is further configured to: display, in the first interaction image, equipment identifications of types of virtual equipment in the equipment set used for interaction by the first virtual character; and use the equipment identifications of the types of virtual equipment as the first indication information that the target account corresponds to the current configuration state.

In some aspects, the second display module is further configured to: display at least one candidate equipment set in the first interaction image, and use a candidate equipment state as the candidate configuration state.

In some aspects, the third display module is further configured to: switch, in response to a selection operation performed on a target equipment set among the at least one candidate equipment set, the first interaction image to the second interaction image of interaction performed, in the virtual scene, by the first virtual character by using the target equipment set; and display, in the second interaction image, an equipment identification of virtual equipment included in the target equipment set, to use the equipment identification of the virtual equipment included in the target equipment set as the second indication information of the target configuration state.

In some aspects, before displaying the at least one candidate equipment set in the first interaction image, the apparatus further includes: an equipment configuration module, configured to configure each candidate equipment set in the following manner: displaying an equipment configuration interface, and displaying, on the equipment configuration interface, an equipment adding control for adding virtual equipment; displaying a target quantity of added virtual equipment in response to an equipment adding operation that is triggered based on the equipment adding control; and generating, in response to an equipment set generation operation, the candidate equipment set including the target quantity of virtual equipment.

The aspects described herein provide a computer program product. The computer program product includes a computer program or computer-executable instructions. The computer program or computer-executable instructions are stored in a computer-readable storage medium. A processor of an electronic device reads the computer-executable instruction from the computer-readable storage medium, and the processor executes the computer-executable instruction, to cause the electronic device to perform the above method for interaction in the virtual scene according to the aspects described herein.

The aspects described herein provide a computer-readable storage medium having a computer-executable instruction or a computer program stored therein. The computer-executable instruction or the computer program, when executed by a processor, causes the processor to perform a method for interaction in a virtual scene according to the aspects described herein, for example, the method for interaction in the virtual scene shown in FIG. 3.

In some aspects, the computer-readable storage medium may be a memory such as a ferroelectric random access memory (FRAM), a ROM, a programmable read-only memory (PROM), an erasable programmable read-only memory (EPROM), an electrically erasable programmable read-only memory (EEPROM), a flash memory, a magnetic surface memory, an optical disk, or a CD-ROM. The computer-readable storage medium may include one or any combination of the aforementioned memories.

In some aspects, the computer-executable instructions may be written in the form of program, software, software module, script, or code in any form of programming language (including compilation or interpretation language, or declarative or procedural language), and the computer executable instructions may be deployed in any form, including being deployed as an independent program or being deployed as a module, component, subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a HyperText Markup Language (HTML) file, stored in a file that is specially used for a program in discussion, or stored in a plurality of collaborative files (for example, be stored in files of one or more modules, subprograms, or code parts).

In an example, the computer-executable instructions may be deployed to be executed on one electronic device, on a plurality of electronic devices located at one site, or on a plurality of electronic devices distributed at a plurality of locations and connected by a communication network.

The foregoing descriptions are only an example described herein and are not intended to limit the scope of protection described herein. Any modification, equivalent replacement, or improvement made within the spirit and scope described herein falls within the protection scope described herein.

What is claimed is:

1. A computer implemented method, comprising:
displaying in a virtual scene corresponding to a first virtual character controlled by a target account, first indication information that the target account corresponds to a current configuration state,
the current configuration state comprising one or more of the following:
an interaction team to which the first virtual character controlled by the target account belongs, wherein the interaction team comprises at least one virtual character, or
an equipment set used for interaction by the first virtual character, wherein the equipment set comprises at least two types of virtual equipment;
displaying at least one candidate configuration state in response to a switching operation performed on the current configuration state;
switching, in response to a received selection operation performed on a target configuration state, the target account to the target configuration state; and
displaying second indication information of the target configuration state in the second interaction image.

2. The method of claim 1, wherein the displaying first indication information that the target account corresponds to the current configuration state comprises:
displaying, in a target region having a preset transparency, the first indication information that the target account corresponds to the current configuration state, wherein the target region is a partial region of the virtual scene; and
the displaying at least one candidate configuration state in the first interaction image comprises:
displaying the at least one candidate configuration state in the target region.

3. The method of claim 1, wherein the received selection operation comprises one or more of:
receiving a first trigger operation performed on the first indication information, and using the first trigger operation as the switching operation performed on the current configuration state;
receiving a second trigger operation performed on a switch control for switching the current configuration state, and using the second trigger operation as the switching operation performed on the current configuration state;
displaying prompt information for prompting switching of a configuration state, and determining, when a confirming operation performed on the prompt information is received, that the confirming operation is the switching operation performed on the current configuration state; or
displaying a display duration of the first indication information, and receiving the switching operation performed on the current configuration state when the display duration reaches a target duration.

4. The method of claim 1, wherein when the current configuration state comprises the interaction team to which the first virtual character controlled by the target account belongs, and wherein the displaying first indication information that the target account corresponds to a current configuration state comprises:
displaying a character identification of the first virtual character when the interaction team to which the first virtual character belongs comprises one virtual character;
when the interaction team to which the first virtual character belongs comprises at least two virtual characters, displaying character identifications of the virtual characters in the interaction team; and
using the character identification as the first indication information that the target account corresponds to the current configuration state.

5. The method of claim 4, wherein the displaying at least one candidate configuration state comprises:
displaying at least one candidate interaction team, and using each of the at least one candidate interaction team as a candidate configuration state.

6. The method of claim 5, wherein the displaying at least one candidate interaction team comprises:
displaying, when a quantity of the candidate interaction teams is at least two, the candidate interaction teams in a form of a team list; or,
displaying the candidate interaction teams in a scrolling manner.

7. The method of claim 5, wherein the displaying at least one candidate interaction team comprises:
obtaining, when a quantity of the candidate interaction teams is at least two, an impact parameter for affecting selection priorities of the candidate interaction teams,
the impact parameter comprising at least one of the following: interaction attributes of the candidate interaction teams, character features of virtual characters comprised in the candidate interaction teams, or historical interaction features of the candidate interaction teams; and
determining the selection priorities of the candidate interaction teams based on the impact parameter, and displaying the candidate interaction teams in display styles corresponding to the selection priorities.

8. The method of claim 5, further comprising, after the displaying at least one candidate interaction team:
displaying, in a display region of each candidate interaction team, a character identification of at least one virtual character comprised in the corresponding candidate interaction team; or
displaying a team attribute identification of each candidate interaction team in a display region of each candidate interaction team.

9. The method of claim 5, wherein the switching, in response to the received selection operation performed on the target configuration state, comprises:
displaying, in the second interaction image, a character identification of each virtual character in the target interaction team, to use the character identification of each virtual character in the target interaction team as the second indication information of the target configuration state.

10. The method of claim 5, further comprising, before the displaying at least one candidate interaction team:
configuring each candidate interaction team by:
displaying a team configuration interface, and displaying an interaction team template on the team configuration interface, the interaction team template comprising a plurality of available positions for placing virtual characters;
displaying added virtual characters at the available positions in the interaction team template in response to a character adding operation; and
generating, in response to a team generation operation, a candidate interaction team comprising the added virtual characters.

11. The method of claim 10, further comprising, before displaying the added virtual characters at the available positions in the interaction team template:
displaying, in the interaction team template, first adding controls for adding virtual characters, the first adding controls and the available positions being in a one-to-one correspondence;
displaying at least two candidate virtual characters for selection in response to a trigger operation performed on a first adding control corresponding to a target position selected from the plurality of available positions; and
receiving, in response to a selection operation performed on a target virtual character, a character adding operation performed on the target position, the character adding operation instructing the target virtual character to be added to the target position.

12. The method of claim 10, wherein the displaying added characters at the available positions comprises:
displaying, in the interaction team template, a second adding control for adding a virtual character, the second adding control corresponding to the plurality of available positions;
displaying at least two candidate virtual characters for selection in response to a trigger operation performed on the second adding control; and
displaying, in response to a character adding operation performed on a target quantity of candidate virtual characters, a target virtual character among the target quantity of candidate virtual characters at the available positions in the interaction team template,
wherein an adaptation degree between the target virtual character displayed at the available positions and the corresponding available positions exceeds an adaptation degree threshold.

13. The method of claim 10, wherein the displaying selected virtual characters at the available positions comprises:
displaying, in the interaction team template, a third adding control for adding a virtual character, the third adding control corresponding to the plurality of available positions;
displaying at least two candidate virtual characters for selection in response to a trigger operation performed on the third adding control; and
displaying, in response to a dragging operation performed on a target virtual character, the target virtual character at a available position indicated by the dragging operation in the interaction team template.

14. The method of claim 1, wherein when the current configuration state comprises the equipment set used for interaction by the first virtual character, the displaying first indication information that the target account corresponds to the current configuration state comprises:
displaying equipment identifications of types of virtual equipment in the equipment set used for interaction by the first virtual character; and
using the equipment identifications of the types of virtual equipment as the first indication information that the target account corresponds to the current configuration state.

15. The method of claim 11, wherein the displaying at least one candidate configuration state in the first interaction image comprises:
displaying at least one candidate equipment set in the first interaction image, and using one of the at least one candidate equipment sets as the candidate configuration state.

16. The method of claim 15, wherein the switching, in response to the received selection operation performed on the target configuration state comprises:
displaying an equipment identification of virtual equipment comprised in the target equipment set, to use the equipment identification of the virtual equipment comprised in the target equipment set as the second indication information of the target configuration state.

17. The method of claim 15, further comprising, before the displaying at least one candidate equipment set in the first interaction image:
configuring each candidate equipment set by:
displaying an equipment configuration interface, and displaying, on the equipment configuration interface, an equipment adding control for adding virtual equipment;
displaying a target quantity of added virtual equipment in response to an equipment adding operation that is triggered based on the equipment adding control; and
generating, in response to an equipment set generation operation, the candidate equipment set comprising the target quantity of virtual equipment.

18. One or more non-transitory computer readable media comprising computer executable instructions which, when executed by a processor, configure a data processing system to perform:
displaying in a virtual scene corresponding to a first virtual character controlled by a target account, first indication information that the target account corresponds to a current configuration state,
the current configuration state comprising one or more of the following:
an interaction team to which the first virtual character controlled by the target account belongs, wherein the interaction team comprises at least one virtual character, or
an equipment set used for interaction by the first virtual character, wherein the equipment set comprises at least two types of virtual equipment;
displaying at least one candidate configuration state in response to a switching operation performed on the current configuration state;
switching, in response to a received selection operation performed on a target configuration state, the target account to the target configuration state; and
displaying second indication information of the target configuration state in the second interaction image.

19. The computer-readable media of claim 18, wherein:
when the current configuration state comprises the interaction team to which the first virtual character controlled by the target account belongs, and wherein the displaying first indication information that the target account corresponds to a current configuration state comprises:
displaying a character identification of the first virtual character when the interaction team to which the first virtual character belongs comprises one virtual character;
when the interaction team to which the first virtual character belongs comprises at least two virtual characters, displaying character identifications of the virtual characters in the interaction team; and
using the character identification as the first indication information that the target account corresponds to the current configuration state, and
when the current configuration state comprises the equipment set used for interaction by the first virtual character, the displaying first indication information that the target account corresponds to the current configuration state comprises:
displaying equipment identifications of types of virtual equipment in the equipment set used for interaction by the first virtual character; and
using the equipment identifications of the types of virtual equipment as the first indication information that the target account corresponds to the current configuration state.

20. A system, comprising:
a processor, and
memory storing computer executable instructions which, when executed by the processor, configure the system to perform:
displaying in a virtual scene corresponding to a first virtual character controlled by a target account, first indication information that the target account corresponds to a current configuration state,
the current configuration state comprising one or more of the following:
an interaction team to which the first virtual character controlled by the target account belongs, wherein the interaction team comprises at least one virtual character, or
an equipment set used for interaction by the first virtual character, wherein the equipment set comprises at least two types of virtual equipment;
displaying at least one candidate configuration state in response to a switching operation performed on the current configuration state;
switching, in response to a received selection operation performed on a target configuration state, the target account to the target configuration state; and
displaying second indication information of the target configuration state in the second interaction image.
